(19) United States
(12) Patent Application Publication
(10) Pub. No.: US 2026/0116379 A1
(43) Pub. Date: Apr. 30, 2026

(54) VEHICLE PATH ASSESSMENT TO DETECT AND REACT TO IMPLAUSIBLE DRIVER STEERING INPUTS

(71) Applicant: GM GLOBAL TECHNOLOGY OPERATIONS LLC, Detroit, MI (US)

(72) Inventors: Milad JALALIYAZDI, Richmond Hill (CA); Raza Zarringhalam, Whitby (CA); Kevin Gady, Saline, MI (US)

(21) Appl. No.: 18/925,414

(22) Filed: Oct. 24, 2024

(51) Int. Cl. B60W 30/09; B60W 10/18; B60W 30/095; B60W 50/14

(52) U.S. Cl. CPC B60W 30/09; B60W 10/18; B60W 30/0956; B60W 50/14; B60W 2420/403; B60W 2420/408; B60W 2520/105; B60W 2540/18

(57) ABSTRACT

A path assessment system for a vehicle includes a trajectory calculating module configured to determine an actual trajectory of a vehicle based on an actual position of a steering wheel of the vehicle and an apparent trajectory of the vehicle based on an apparent position of the steering wheel of the vehicle. An obstacle grid generating module is configured to generate an obstacle grid. A collision probability module is configured to determine a probability of a collision based on the obstacle grid and the actual trajectory of the vehicle. A mitigation module is configured to at least one of alert a driver, apply brakes of the vehicle, and alter an acceleration request in response to the probability being greater than a predetermined percentage.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles, and more particularly to a vehicle path assessment system for detecting and correcting for implausible steering inputs to the vehicle.

Vehicles may include a steering wheel, accelerator pedal, and brake pedal that are used to control the direction, acceleration, and speed of the vehicle. While driving, the steering wheel can be rotated multiple times from lock to lock. As a result, the steering wheel can be positioned close to a centered position while the front wheels are not aligned in a straight or near straight direction. In some situations, a driver may not realize that the steering wheel is in an incorrect position and fail to correct the steering wheel position before accelerating the vehicle.

### SUMMARY

A path assessment system for a vehicle includes a trajectory calculating module configured to determine an actual trajectory of a vehicle based on an actual position of a steering wheel of the vehicle and an apparent trajectory of the vehicle based on an apparent position of the steering wheel of the vehicle. An obstacle grid generating module is configured to generate an obstacle grid. A collision probability module is configured to determine a probability of a collision based on the obstacle grid and the actual trajectory of the vehicle. A mitigation module is configured to at least one of alert a driver, apply brakes of the vehicle, and alter an acceleration request in response to the probability being greater than a predetermined percentage.

In other features, the path assessment system includes at least one of a light detection and ranging (LIDAR) sensor, a radar detection and ranging (radar) sensor, and a camera/image sensor.

In other features, the obstacle grid generating module generates the obstacle grid in response to at least one of the LiDAR sensor, the radar sensor, and the camera/image sensor. The apparent position of the steering wheel corresponds to a remainder of an absolute hand wheel angle and 360. The trajectory calculating module determines the actual trajectory and the apparent trajectory of the vehicle before the vehicle begins moving. The trajectory calculating module determines the actual trajectory and the apparent trajectory of the vehicle by assuming nominal acceleration of the vehicle. The trajectory calculating module is enabled in response to a gear selector event. The trajectory calculating module is enabled in response to a gear selector moving from park to forward or reverse. The trajectory calculating module is enabled in response to an absolute value of a road wheel angle being greater than a first threshold. The first threshold is greater than or equal to 5°. The trajectory calculating module is enabled in response to a remainder of an absolute value of a hand wheel angle and 360 is less than a second threshold. The second threshold is less than or equal to 45°.

In other features, the trajectory calculating module is enabled in response to a gear selector moving from park to forward or reverse, an absolute value of a road wheel angle being greater than a first threshold, and a remainder of an absolute value of a hand wheel angle and 360 is less than a second threshold.

A vehicle includes at least one of a light detection and ranging (LiDAR) sensor, a radar detection and ranging (radar) sensor, and a camera/image sensor. A trajectory calculating module is configured to determine an actual trajectory of a vehicle based on an actual position of a steering wheel of the vehicle before the vehicle begins moving and an apparent trajectory of the vehicle based on an apparent position of the steering wheel of the vehicle before the vehicle begins moving, wherein the apparent position of the steering wheel corresponds to remainder of an absolute value of hand wheel angle and 360. An obstacle grid generating module is configured to generate an obstacle grid in response to at least one of the LiDAR sensor, the radar sensor, and the camera/image sensor. A collision probability module is configured to determine a probability of a collision based on the obstacle grid and the actual trajectory of the vehicle. A mitigation module is configured to at least one of alert a driver, apply brakes of the vehicle, and alter an acceleration request in response to the probability being greater than a predetermined percentage.

In other features, the trajectory calculating module determines the actual trajectory and the apparent trajectory of the vehicle by assuming nominal acceleration of the vehicle. The trajectory calculating module is enabled in response to a gear selector moving from park to forward or reverse, an absolute value of a road wheel angle being greater than a first threshold, and a remainder of an absolute value of a hand wheel angle and 360 is less than a second threshold.

In other features, the trajectory calculating module is enabled in response to a gear selector moving from park to forward or reverse. The trajectory calculating module is enabled in response to an absolute value of a road wheel angle being greater than a first threshold. The trajectory calculating module is enabled in response to a remainder of an absolute value of a hand wheel angle and 360 is less than a second threshold. The second threshold is less than or equal to 45°.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A illustrates an example of a steering wheel arranged at a first rotational position and a first corresponding position of front wheels of the vehicle;

FIG. 1B illustrates an example of the steering wheel rotating through various steering wheel angles;

FIG. 1C illustrates an example of a steering wheel at the first rotational position and a second corresponding position of front wheels of the vehicle;

FIG. 2A illustrates an example of a vehicle located in a parking spot with other vehicles located in adjacent parking spots;

FIG. 2B illustrates an example of the steering wheel with a low apparent steering wheel angle and wheels turned at a higher actual angle;

FIG. 2C illustrates an example of collision of the vehicle due to the difference between the actual steering wheel angle and the apparent steering wheel angle;

FIG. 3 illustrates an example of an obstacle grid relative to actual and apparent trajectories according to the present disclosure;

FIG. 4 is a functional block diagram of an example of a vehicle including a driver assistance controller including a vehicle path assessment module according to the present disclosure;

FIG. 5 is a functional block diagram of an example of a portion of the vehicle path assessment module according to the present disclosure;

FIGS. 6A and 6B illustrate actual and apparent trajectories of the vehicle according to the present disclosure; and

FIG. 7 is a flowchart of a method for detecting and reacting to apparent steering wheel positions corresponding to implausible steering angles.

In the drawings, reference numbers may be reused to identify similar and/or identical elements.

### DETAILED DESCRIPTION

There are many instances when a driver of a vehicle may inadvertently provide an incorrect steering input. A steering wheel has a centered position corresponding to wheels of the vehicle pointed in a straight direction. After the steering wheel is rotated 360°, the steering wheel appears to be centered but the wheels are turned away from a straight direction. For example, a steering wheel may have an apparent angle of +10° relative to a centered position. However, the driver may not realize that the actual angle of the steering wheel is really-350° or +370° relative to the centered position (since the steering wheel looks the same at both of these steering wheel angles). Rather than being close to straight, the wheels of the vehicle in may actually be turned at a higher angle.

As can be appreciated, the apparent trajectory of the vehicle as perceived by the driver is different than the actual trajectory of the vehicle. An accident may occur if the driver accelerates the vehicle and there are nearby obstacles in the actual trajectory of the vehicle. Furthermore, there may be insufficient time for the driver to react to the unexpected trajectory of the vehicle.

The vehicle path assessment system according to the present disclosure identifies situations when implausible steering wheel inputs occur. When certain conditions are present, the vehicle path assessment system determines the actual and apparent trajectories of the vehicle, generates an obstacle grid, and identifies the probability of collision based thereon. In some examples, the vehicle path assessment system determines the actual and apparent trajectories of the vehicle before the vehicle begins moving (by assuming nominal acceleration of the vehicle).

If the probability of a collision is greater than a threshold, the vehicle path assessment system generates an alert, disables the accelerator pedal, and/or applies the brakes.

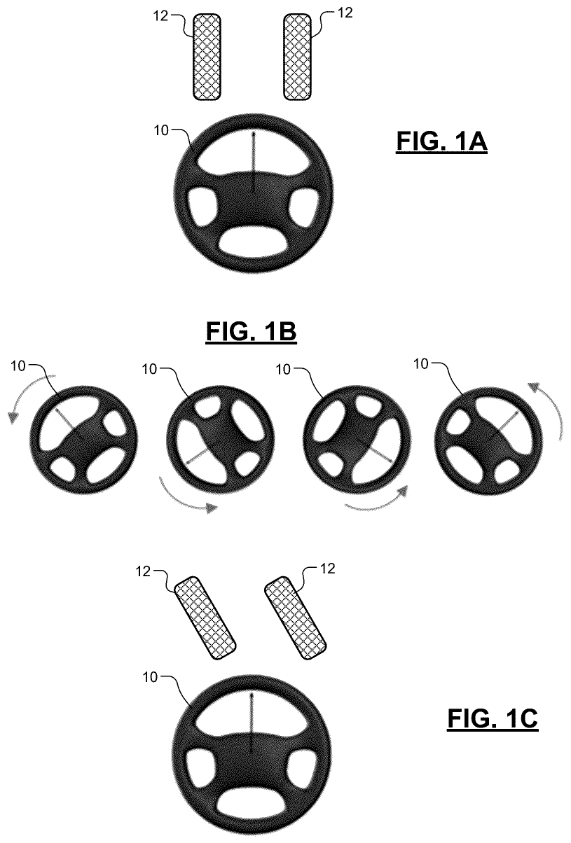

Referring now to FIGS. 1A to 1B, a steering wheel 10 of a vehicle is typically at a centered position when front wheels 12 of the vehicle are straight as shown in FIG. 1C. The steering wheel 10 may be rotated two or more times from lock to lock as shown in FIG. 1B. In some examples, the steering wheel rotates −720° from the centered position to the leftmost angular position and +720° from the centered position to the rightmost angular position. That means that the steering wheel 10 may be close to the centered position for a range of wheel angles that may or may not be close to straight. The driver of the vehicle may incorrectly assume that the actual trajectory of the vehicle is straight or near straight when it is in fact not straight. In other words, the apparent trajectory of the vehicle differs significantly from the actual trajectory.

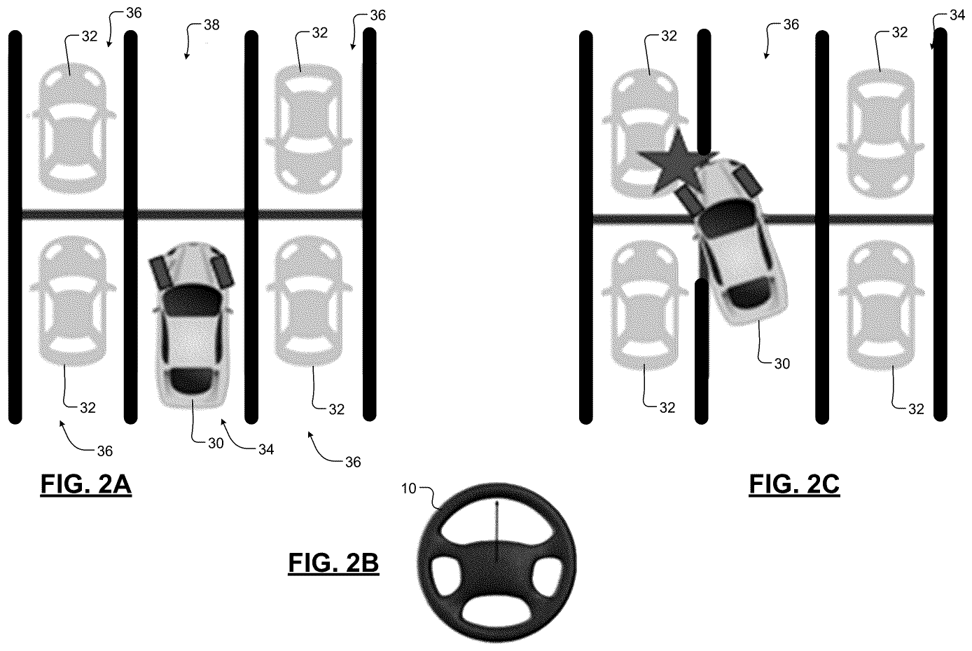

Referring now to FIGS. 2A to 2C, an example of a situation where the mismatch between the apparent trajectory and the actual trajectory of the vehicle are not the same is shown. In FIG. 2A, a vehicle 30 is parked in a parking spot 34. Vehicles 32 are parked in other parking spots 36 surrounding the vehicle 30. A parking spot 38 located in front of the parking spot 34 is open.

In this example, the orientation of the steering wheel 10 of the vehicle 30 appears to be centered (as shown in FIG. 2B) which would correspond to a straight trajectory. However, the driver of the vehicle may not know that the wheels of the vehicle 30 are at a relatively high angle relative to a straight direction. This is an example where the apparent trajectory of the vehicle 30 is different from the actual trajectory of the vehicle 30. If the driver does not understand the actual trajectory of the vehicle, the driver may accelerate the vehicle forward and cause an accident.

The vehicle path assessment module receives sensor data from sensors such as a global position system (GPS), a compass, a radio detection and ranging (radar), a light detection and ranging (LiDAR), images from one or more cameras, etc. Objects in the path of the vehicle and/or on sides of the vehicle are sensed and an obstacle grid or map around the vehicle is generated.

A vehicle path assessment module determines actual and apparent trajectories of the vehicle based on actual and apparent positions of the steering wheel. The vehicle path assessment module identifies potential collisions based on the actual and apparent trajectories and the obstacle grid. If a collision is likely, the vehicle path assessment module generates alerts, disables acceleration and/or applies the brakes of the vehicle based on the assessment. The vehicle path assessment module strikes a practical balance between utility and minimal annoyance.

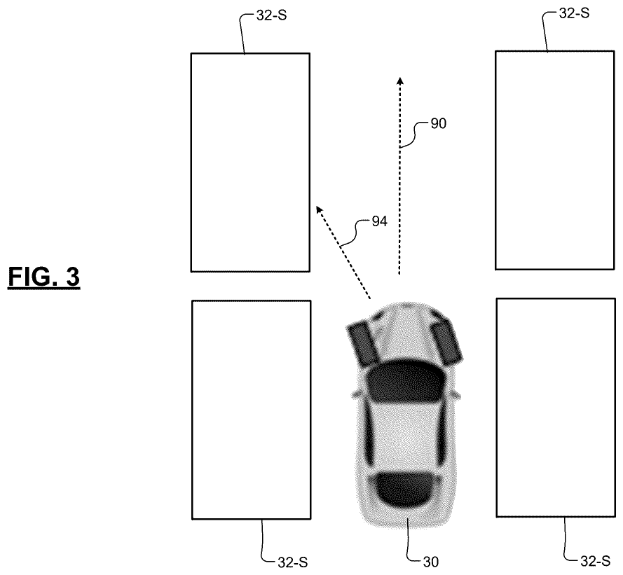

Referring now to FIG. 3, the vehicle 30 is shown relative to an obstacle map including objects in front of and/or surrounding the vehicle. The object map is constructed by the driver assistance controller based on the data from the one or more sensors described further below. In this example, the wheels of the vehicle 30 are at an angle while the steering wheel appears to be close to the centered position. An actual trajectory 94 of the vehicle 30 will likely result in an accident whereas an apparent trajectory 90 of the vehicle 30 would not.

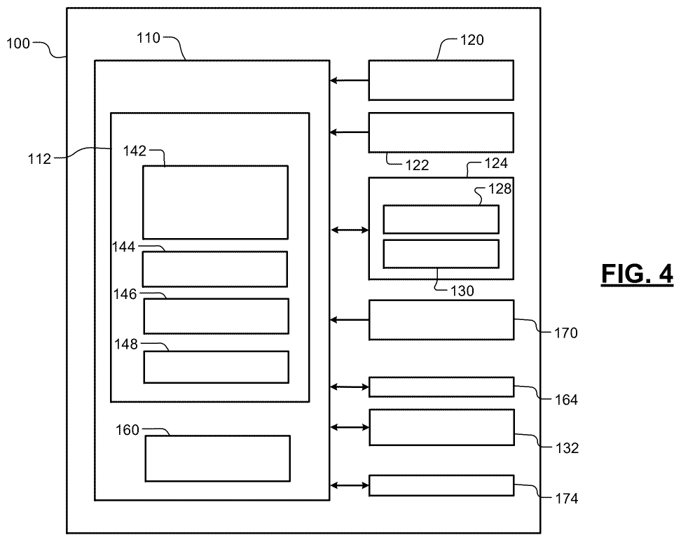

Referring now to FIG. 4, a vehicle 100 includes a driver assistance controller 110 including a vehicle path assessment module 112 configured to identify implausible steering inputs and to initiate mitigating actions such as generating an alert, disabling an accelerator pedal, and/or applying the brakes. The vehicle 100 includes sensors such as a global positioning system (GPS)/compass 120 that determines a position, path, and/or orientation of the vehicle 100 and outputs the GPS/compass data to the driver assistance controller 110.

The vehicle 100 optionally includes one or more radar sensors 122 that generate radio frequency pulses (directed in forward, reverse, and/or side directions) and outputs radar return signals from objects in the corresponding directions to the driver assistance controller 110. The vehicle 100 optionally includes one or more light detection and ranging (LiDAR) sensors 124 that generate light pulses (directed in forward, reverse, and/or side directions) and outputs return signals to the driver assistance controller 110. In some examples, the LiDAR sensor 124 includes one or more lasers 130 and one or more scanners 128 that scan the one or more lasers 130 in a corresponding field of view. The vehicle 100 optionally includes one or more cameras to provide images (in forward, reverse, and/or side directions) and corresponding image analysis modules configured to detect objects in the images as shown at 132.

In some examples, the driver assistance controller 110 includes an autonomous driving module 160 configured to operate the vehicle 100 in fully and/or partially autonomous driving modes by controlling vehicle controls 164 (such as a steering wheel, a brake pedal, an acceleration pedal, turn signals, transmission gear selector, etc.) based on outputs of the one or more radar sensors 122, the one or more LiDAR sensors 124, and/or other sensors. In some examples, the vehicle path assessment module 112 monitors for implausible steering wheel inputs when the autonomous driving module 160 is not activated.

The vehicle path assessment module 112 includes an actual and apparent trajectory calculating module 142 configured to determine the actual and apparent trajectories of the vehicle 100 based on the actual and apparent steering wheel position. An obstacle grid generating module 144 is configured to generate an obstacle grid or map based on the outputs of the radar sensor 122, the LiDAR sensor 124, and/or the camera/image analysis module 132.

A collision probability module 146 is configured to calculate the probability of a collision between the vehicle 100 and an object for the actual and apparent trajectories. When the collision probability is greater than a predetermined probability, a mitigation module 148 selectively generates an alert, disables the accelerator pedal, and/or applies the brakes. The driver assistance controller 110 also receives data from other vehicle sensors 170 such as vehicle speed, acceleration, etc. A human machine interface (HMI) 174 includes a display such as a touchscreen that receives inputs from and/or provides alerts to the driver.

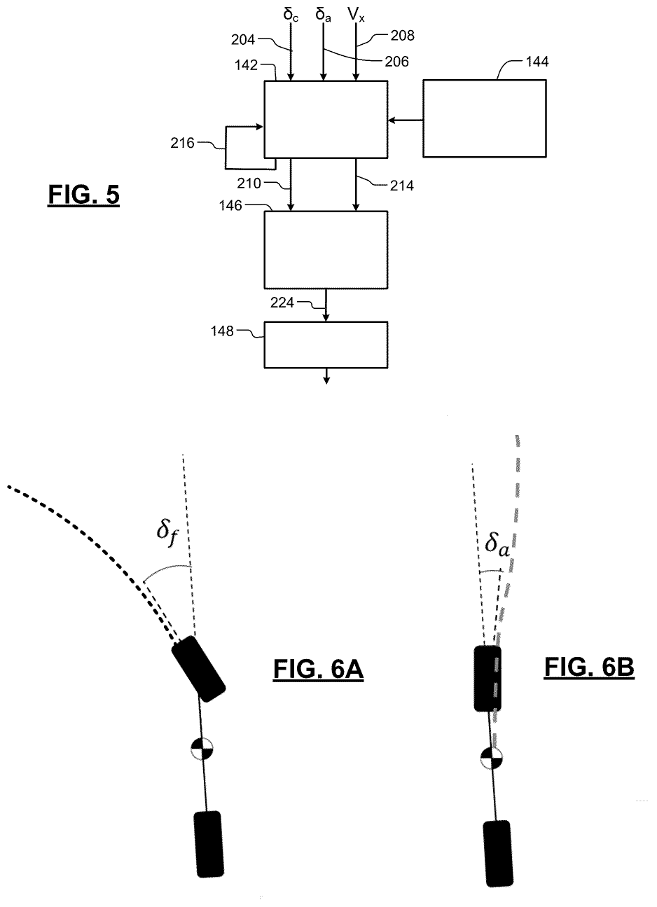

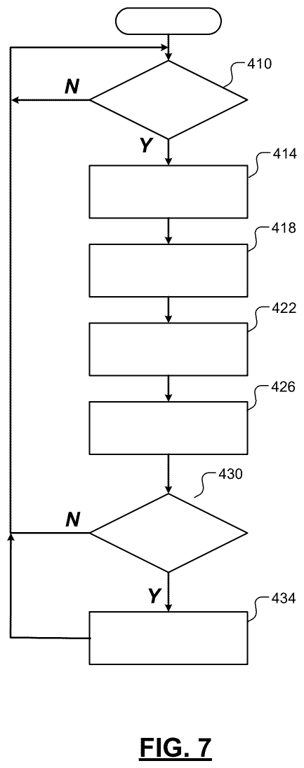

Referring now to FIGS. 5 to 6B, the current and apparent trajectory calculating module 142 receives a current steering angle δ_{c}, an apparent steering angle δₐ, and a predictive speed based on nominal acceleration Vₓ. The current and apparent trajectory calculating module 142 is configured to generate and output an actual/current trajectory 210 ((xᵢ, yᵢ)ϵT_{c}) (FIG. 6A) based on the actual steering wheel position and an apparent trajectory 214 (FIG. 6B) ((xⱼ, yⱼ)ϵTₐ) based on the apparent steering wheel position of the vehicle to the collision probability module 146. In some examples, the actual trajectory 210 and the apparent trajectory 214 are calculated using two instances of a plant model. In some examples, the plant model includes:

$$\frac{d}{dt} [ \begin{matrix}y \\ {V}_{y} \\ ψ \\ {ψ}^{`}\end{matrix} ] = [ \begin{matrix}0 & 1 & {V}_{x} & 0 \\ 0 & - \frac{{C}_{f} + {C}_{r}}{m {V}_{x}} & 0 & - {V}_{x} - \frac{{C}_{f} {l}_{f} - {C}_{r} {l}_{r}}{m {V}_{x}} \\ 0 & 0 & 0 & 1 \\ 0 & - \frac{{C}_{f} {l}_{f} - {C}_{r} {l}_{r}}{{I}_{z} {V}_{x}} & 0 & - \frac{{C}_{f} {l}_{f}^{2} - {C}_{r} {l}_{r}^{2}}{{I}_{z} {V}_{x}}\end{matrix} ] [ \begin{matrix}y \\ {V}_{y} \\ ψ \\ {ψ}^{`}\end{matrix} ] + [ \begin{matrix}0 \\ \frac{{C}_{f}}{m} \\ 0 \\ \frac{{C}_{f} {l}_{f}}{{I}_{z}}\end{matrix} ] δ$$

where Cₜ and C_{y} are front and rear axle cornering stiffness, I_{f} and I_{y} are distances from center of gravity to the front and rear axles, m is the mass of the vehicle, I_{z} is the moment of inertia, Vₓ and V_{y} are longitudinal and lateral vehicle speed, x and y are longitudinal and lateral position, w and v are yaw angle and yaw rate, and δ_{c} and δₐ are current and actual road steering angle.

The collision probability module 146 is configured to determine the probability of collision relative to the actual trajectory 210, the apparent trajectory 214, and the obstacle grid or map (e.g., the obstacle grid is generated based data from the sensors (e.g., radar, LiDAR, camera, etc.)). In some examples, the collision probability is based on the following model:

$$∀ ( {x}_{i} , {y}_{i} ) ∈ {O}_{g} , ∀ ( {x}_{j} , {y}_{j} ) ∈ {T}_{c}$$

$$\begin{matrix}{D}_{{ij}_{c}} = {( {( {x}_{i} - {x}_{j} )}^{2} + {( {y}_{i} - {y}_{j} )}^{2} )}^{\frac{1}{2}} \\ {P}_{c} = f ( {D}_{{ij}_{c}} , {Q}_{l} , {Q}_{o} )\end{matrix}$$

$$∀ ( {x}_{i} , {y}_{i} ) ∈ {O}_{g} , ∀ ( {x}_{j} , {y}_{j} ) ∈ {T}_{a}$$

$$\begin{matrix}{D}_{{ij}_{a}} = {( {( {x}_{i} - {x}_{j} )}^{2} + {( {y}_{i} - {y}_{j} )}^{2} )}^{\frac{1}{2}} \\ {P}_{a} = f ( {D}_{{ij}_{a}} , {Q}_{l} , {Q}_{o} )\end{matrix}$$

$$P = g ( {P}_{c} , {P}_{a} )$$

where D_{ijc} and Dᵢⱼₐ are distances between current and apparent trajectory and occupancy grid, Pₐ and P_{c} are probabilities of collision of apparent and current paths with the occupancy grid, Qₗ and Qₒ are the quality of the lane and object detection, f ( . . . ) is a probability function that maps distance of generated trajectory to collision probability, g ( . . . ) is a probability function that maps apparent/current collision probability to implausible steering input, P is the probably of implausible steering input, T_{c} and Tₐ are the collection of (x,y) points on the current/apparent trajectory, and O_{g} is the occupancy grid.

Referring now to FIG. 7, a method for detecting implausible inputs to a steering wheel are shown. At 410, the method determines whether enabling conditions are met. Examples of enabling conditions include vehicle speed within a predetermined range, gear selector events (such as moving from park to a forward gear or reverse), Abs (road wheel angle)>first threshold, and/or remainder (abs (hand wheel angle), 360)<second threshold. In some examples, the first threshold is greater than or equal to 5°. In some examples, the second threshold is less than or equal to 45°.

At 414, object information is collected from the sensors. At 418, a map of objects surrounding the vehicle is generated based on the collected data from the sensors. At 422, an actual vehicle path is generated from the actual steering wheel angle. At 426, an apparent vehicle path is generated from the apparent steering wheel angle. At 430, the method determines whether a collision is probably with nominal acceleration withing a predetermined period (e.g., x seconds). At 434, the method issues an alert, disables the accelerator, and/or applies the brakes.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A path assessment system for a vehicle, comprising:
a trajectory calculating module configured to determine:
an actual trajectory of a vehicle based on an actual position of a steering wheel of the vehicle; and
an apparent trajectory of the vehicle based on an apparent position of the steering wheel of the vehicle;
an obstacle grid generating module configured to generate an obstacle grid;
a collision probability module configured to determine a probability of a collision based on the obstacle grid and the actual trajectory of the vehicle; and
a mitigation module configured to at least one of alert a driver, apply brakes of the vehicle, and alter an acceleration request in response to the probability being greater than a predetermined percentage.

2. The path assessment system of claim 1, further comprising at least one of:
a light detection and ranging (LiDAR) sensor;
a radar detection and ranging (radar) sensor; and
a camera/image sensor.

3. The path assessment system of claim 2, wherein the obstacle grid generating module generates the obstacle grid in response to at least one of the LiDAR sensor, the radar sensor, and the camera/image sensor.

4. The path assessment system of claim 1, wherein the apparent position of the steering wheel corresponds to a remainder of an absolute hand wheel angle and 360.

5. The path assessment system of claim 1, wherein the trajectory calculating module determines the actual trajectory and the apparent trajectory of the vehicle before the vehicle begins moving.

6. The path assessment system of claim 1, wherein the trajectory calculating module determines the actual trajectory and the apparent trajectory of the vehicle by assuming nominal acceleration of the vehicle.

7. The path assessment system of claim 1, wherein the trajectory calculating module is enabled in response to a gear selector event.

8. The path assessment system of claim 1, wherein the trajectory calculating module is enabled in response to a gear selector moving from park to forward or reverse.

9. The path assessment system of claim 1, wherein the trajectory calculating module is enabled in response to an absolute value of a road wheel angle being greater than a first threshold.

10. The path assessment system of claim 9, wherein the first threshold is greater than or equal to 5°.

11. The path assessment system of claim 1, wherein the trajectory calculating module is enabled in response to a remainder of an absolute value of a hand wheel angle and 360 is less than a second threshold.

12. The path assessment system of claim 11, wherein the second threshold is less than or equal to 45°.

13. The path assessment system of claim 1, wherein the trajectory calculating module is enabled in response to:
a gear selector moving from park to forward or reverse;
an absolute value of a road wheel angle being greater than a first threshold; and
a remainder of an absolute value of a hand wheel angle and 360 is less than a second threshold.

14. A vehicle comprising:
at least one of a light detection and ranging (LIDAR) sensor, a radar detection and ranging (radar) sensor, and a camera/image sensor;
a trajectory calculating module configured to determine:
an actual trajectory of a vehicle based on an actual position of a steering wheel of the vehicle before the vehicle begins moving; and
an apparent trajectory of the vehicle based on an apparent position of the steering wheel of the vehicle before the vehicle begins moving, wherein the apparent position of the steering wheel corresponds to remainder of an absolute value of hand wheel angle and 360;
an obstacle grid generating module configured to generate an obstacle grid in response to at least one of the LiDAR sensor, the radar sensor, and the camera/image sensor;
a collision probability module configured to determine a probability of a collision based on the obstacle grid and the actual trajectory of the vehicle; and
a mitigation module configured to at least one of alert a driver, apply brakes of the vehicle, and alter an acceleration request in response to the probability being greater than a predetermined percentage.

15. The vehicle of claim 14, wherein the trajectory calculating module determines the actual trajectory and the apparent trajectory of the vehicle by assuming nominal acceleration of the vehicle.

16. The vehicle of claim 14, wherein the trajectory calculating module is enabled in response to:
a gear selector moving from park to forward or reverse;
an absolute value of a road wheel angle being greater than a first threshold; and
a remainder of an absolute value of a hand wheel angle and 360 is less than a second threshold.

17. The vehicle of claim 14, wherein the trajectory calculating module is enabled in response to a gear selector moving from park to forward or reverse.

18. The vehicle of claim 14, wherein the trajectory calculating module is enabled in response to an absolute value of a road wheel angle being greater than a first threshold.

19. The vehicle of claim 14, wherein the trajectory calculating module is enabled in response to a remainder of an absolute value of a hand wheel angle and 360 is less than a second threshold.

20. The vehicle of claim 19, wherein the second threshold is less than or equal to 45°.
